(19) United States
(12) Patent Application Publication
(10) Pub. No.: US 2016/0196064 A1
(43) Pub. Date: Jul. 7, 2016

(54) STORAGE CONTROL DEVICE, CONTROL METHOD AND STORAGE SYSTEM

(71) Applicant: FUJITSU LIMITED, Kawasaki-shi (JP)

(72) Inventor: YUJI NODA, Kahoku (JP)

(73) Assignee: FUJITSU LIMITED, Kawasaki-shi (JP)

(21) Appl. No.: 14/939,546

(22) Filed: Nov. 12, 2015

(30) Foreign Application Priority Data
Jan. 7, 2015 (JP) 2015-001668

(51) Int. Cl. G06F 3/06; G06F 12/08

(52) U.S. Cl. CPC G06F 3/061; G06F 3/0629; G06F 3/0685; G06F 12/0802; G06F 2212/205; G06F 2212/22

(57) ABSTRACT

A storage control device includes: a processor; a second memory device coupled to a first memory device so as to be capable of communicating with the first memory device, and having a higher data access performance than a data access performance of the first memory device, the processor is configured to: predict, as a first prediction time, a read-out process time for reading out data from the first memory device; predict, as a second prediction time, a read-out process time for reading out data from the second memory device; compare the first prediction time and the second prediction time to each other; and read out, when the first prediction time is equal to or more than the second prediction time data from the second memory device and, when the first prediction time is less than the second prediction time data from the first memory device.

### CROSS-REFERENCE TO RELATED APPLICATION

This application is based upon and claims the benefit of priority of the prior Japanese Patent Application No. 2015-001668, filed on Jan. 7, 2015, the entire contents of which are incorporated herein by reference.

### FIELD

The embodiments discussed herein are related to a storage control device, a control method, and a storage system.

### BACKGROUND

Reduction in cost and increase in capacity and performance for solid state drives (SSDs) which employ a flash memory for a memory medium have been further advanced.

Related art is described in Japanese Laid-open Patent Publication No. 2013-77161, Japanese Laid-open Patent Publication No. 2013-65060, or Japanese Laid-open Patent Publication No. 2012-103853.

### SUMMARY

According to an aspect of the embodiments, a storage control device includes: a processor; a second memory device coupled to a first memory device so as to be capable of communicating with the first memory device, and having a higher data access performance than a data access performance of the first memory device, the processor is configured to: predict, as a first prediction time, a read-out process time for reading out data from the first memory device; predict, as a second prediction time, a read-out process time for reading out data from the second memory device; compare the first prediction time and the second prediction time to each other; and read out, when the first prediction time is equal to or more than the second prediction time data from the second memory device and, when the first prediction time is less than the second prediction time data from the first memory device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of data read-out processing in a storage system;

FIG. 2 illustrates an example of a functional configuration of a storage system;

FIG. 3 illustrates an example of an HDD basic performance table;

FIG. 4 illustrates an example of an SSD basic performance table;

FIG. 5 illustrates an example of data read target device selection processing;

FIG. 6 illustrates an example of HDD basic performance table generation processing;

FIG. 7 illustrates an example of HDD load value monitoring processing;

FIG. 8 illustrates an example of data read target device selection processing;

FIG. 9 illustrates an example of an SSD response time table;

FIG. 10 illustrates an example of a functional configuration of a storage system; and

FIG. 11 illustrates an example of data read target device selection processing.

### DESCRIPTION OF EMBODIMENT

In a storage device for entertainment, in addition to a volatile memory, such as a dynamic random access memory (DRAM), a double data rate synchronous DRAM (DDR SDRAM), and the like, an SSD is employed as a data cache, and thus, increase in high performance is achieved.

SSDs have the following characteristics, as compared to a volatile memory (which will be herein after referred to as a “DRAM/DDR”).

(1) An SSD has a large capacity and may be used as an inexpensive nonvolatile memory.

(2) An SSD has a lower access performance than that of a DRAM/DDR.

For example, a DRAM/DDR which has a high access performance is used as a primary cache, and an SSD is used as a secondary cache.

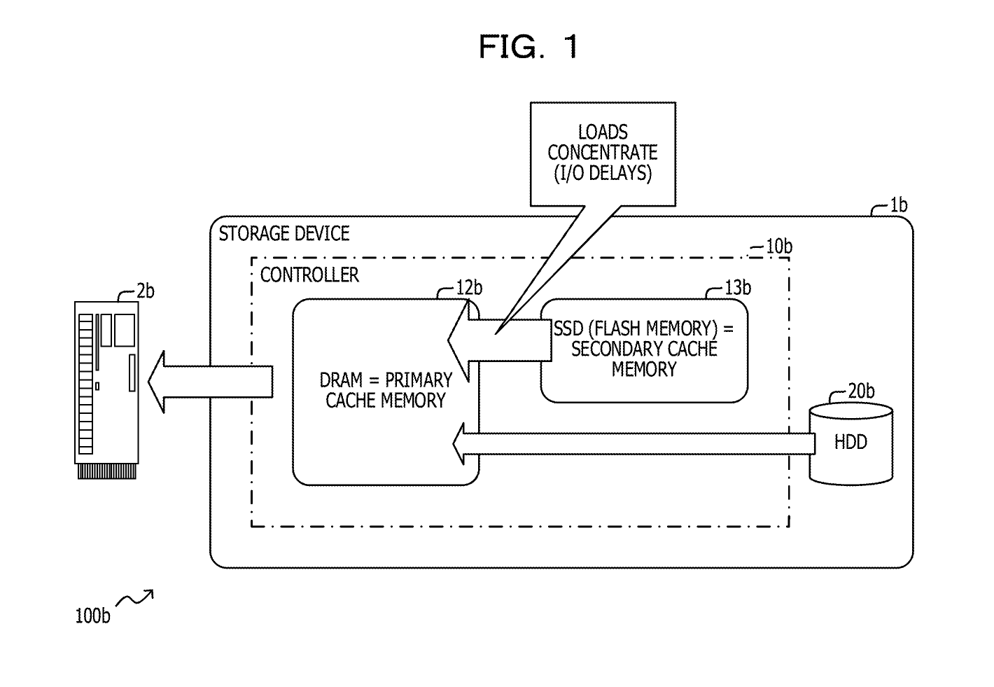

FIG. 1 illustrates an example of data read-out processing in a storage system. A storage system 100b includes a storage device 1b and a host device 2b. The host device 2b is a computer (an information processor) having a server function.

The storage device 1b is a device that provides a memory area to the host device 2b, and includes a controller 10b and a hard disk drive (HDD) 20b. The HDD 20b is a device that stores data such that the data may be read and written. The HDD 20b may be a known device. In FIG. 1, a single HDD 20b is provided, but the storage device 1b may include a plurality of HDDs 20b.

A controller 10b includes a central processing unit, a DRAM 12b, and an SSD 13b. In FIG. 1, in order to increase an access speed for accessing data stored in the HDD 20b, the DRAM 12b is used as a primary cache memory, and the SSD 13b is used as a secondary cache memory.

When input and output (I/O) from the host device 2b occur in the storage system illustrated in FIG. 1, the storage device 1b checks whether or not there is an I/O target data hit in the primary cache memory 12b or the secondary cache memory 13b. If there is an I/O target data hit in the primary cache memory 12b or the secondary cache memory 13b, the storage device 1b reads out the I/O target data from the primary cache memory 12b or the secondary cache memory 13b. If there is not an I/O target data hit in the primary cache memory 12b or the secondary cache memory 13b, the storage device 1b reads out the I/O target data from the HDD 20b.

In the data read-out processing illustrated in FIG. 1, because of characteristics of accesses to the secondary cache memory 13b, there might be cases where a cache hit ratio in the secondary cache memory 13b greatly depends on an access pattern from the host device 2b. The secondary cache memory 13b caches pieces of data of the plurality of HDDs 20b in the storage device 1b, and therefore, there may be cases where accesses concentrate to the secondary cache memory 13b.

In the secondary cache memory 13b a cache hit ratio of which has been increased and thus a load of which has been increased, I/O piles up and reduction in performance (a response delay) at a cache hit might be caused.

Each configuration illustrated in the accompanying drawings may include, in addition to components illustrated in the drawings, other functions and the like.

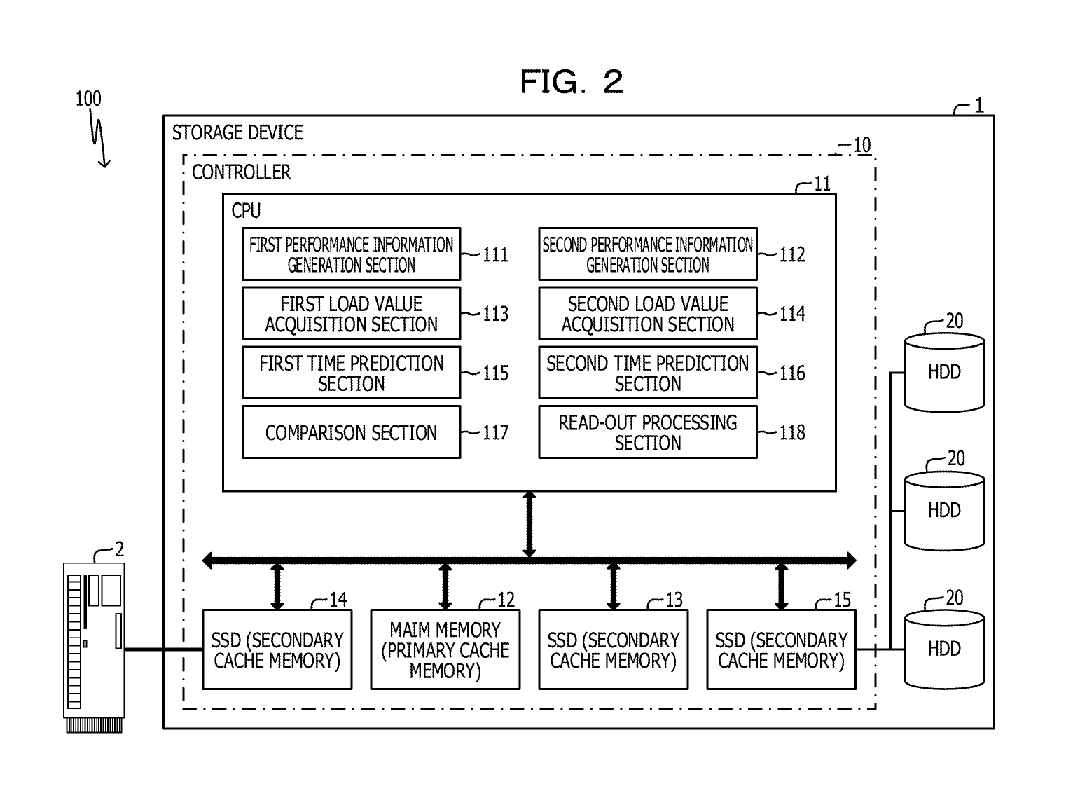

In the drawings, similar parts are denoted by the same reference character, and therefore, the description thereof might be omitted or reduced hereinafter. FIG. 2 illustrates an example of a functional configuration of a storage system.

A storage system 100 illustrated in FIG. 2 provides a memory area to a host device 2, and includes a storage device 1 and the host device 2. The host device 2 may be, for example, a computer (an information processor) having a server function. The storage system 100 illustrated in FIG. 2 includes a single host device 2, but the storage system 100 may include a plurality of host devices 2.

The storage device 1 includes a controller 10, for example, a storage control device and one or more (three in FIG. 2) HDDs 20, for example, one or more first memory devices. The storage device 1 may be a device that provides a memory area to the host device 2 using the HDDs 20. The storage device 1 distributes data to the plurality of HDDs 20 using redundant arrays of inexpensive disks (RAID) and saves the data in a redundant state.

The HDDs 20 are magnetic recording mediums that store data such that the data may be read and written, and are used as auxiliary memory devices (external memory devices). The HDDs 20 may have functional configurations that are similar to one another. The controller 10 may be a control device that performs various kinds of controls, and performs each of the various kinds of controls in accordance with a storage access request, for example, an access control signal (which will be hereinafter referred to as a “host I/O”), from the host device 2. The controller 10 may include a CPU (a computer) 11, a main memory (a volatile memory) 12, an SSD (a second memory device) 13, a host coupling I/C controller 14, and an HDD coupling I/O controller 15.

The host coupling I/C controller 14 may be an interface controller that couples the controller 10 and the host device 2 to each other such that the controller 10 and the host device 2 may communicate with each other. The host coupling I/C controller 14 and the host device 2 may be coupled to each other, for example, via a local area network (LAN) cable. The HDD coupling I/O controller 15 is an interface controller that couples the controller 10 and each of the HDDs 20 to each other such that the controller 10 and the HDD 20 may communicate with each other, and may be, for example, a fibre channel (FC) adapter. The controller 10 writes and reads out data to and from the HDDs 20 via the HDD coupling I/O controller 15. Note that, in the example of FIG. 1, the controller 10 includes a single HDD coupling I/O controller 15, but the controller 10 may include two or more HDD coupling I/O controllers 15.

The main memory 12 is a memory device including a read only memory (ROM) and a random access memory (RAM). A program, such as a basic input/output system (BIOS) and the like, is written in the ROM of the main memory 12. A software program on the main memory 12 is read and executed by the CPU 11, as appropriate. The RAM of the main memory 12 may be used as one cache memory (a primary recording memory) or a working memory.

In the following description, there are cases where the main memory 12 refers to the RAM. An SSD 13 is a semiconductor recording medium that stores data such that the data may be read and written, and is used as a second cache memory. The SSD 13 is coupled to the CPU 11, for example, via a peripheral component interconnect express (PCIe). In FIG. 2, the storage control device 10 includes a single SSD 13, but the storage control device 10 may include a plurality of SSDs 13.

The main memory 12 may have a higher data access performance (basic performance) than that of the SSD 13, and the SSD 13 may have a higher data access performance than that of the HDDs 20. For example, when the same number of commands are issued to the main memory 12, the SSD 13, and the HDDs 20 from the host device 2 under the same condition, for example, in a state where the quality at the time of shipping from the factory is maintained, the data access speed of accesses to the main memory 12 may be the highest and the data access speed of accesses to the HDDs 20 may be the lowest.

The CPU 11 is a processor that performs various kinds of controls and operations, and executes an operating system (OS) and a program stored in the main memory 12, so that the various kinds of functions are executed. For example, as illustrated in FIG. 2, the CPU 11 functions as a first performance information generation section 111, a second performance generation section 112, a first load value acquisition section 113, a second load value acquisition section 114, a first time prediction section 115, a second time prediction section 116, a comparison section 117, and a read-out processing section 118.

A program (a control program) used for executing functions as the first performance information generation section 111, the second performance generation section 112, the first load value acquisition section 113, the second load value acquisition section 114, the first time prediction section 115, the second time prediction section 116, the comparison section 117, and the read-out processing section 118 is provided in a form recorded in a computer-readable recording medium, for example, a flexible disk, a CD (a CD-ROM, a CD-R, a CD-RW, or the like), a DVD (a DVD-ROM, a DVD-RAM, a DVD-R, a DVD+R, a DVD-RW, a DVD+RW, an HD DVD, or the like), a Blu-ray Disk, a magnetic disk, an optical disk, a magneto-optical disk, and the like. The computer reads the program from the recording medium via a read device, transfers the program to an internal recording device or an external recording device to store the program therein, and uses the program. The program may be recorded, for example, in a memory device (a recoding medium), for example, a magnetic disk, an optical disk, a magnetooptical disk and the like, and may be provided to the computer from the memory device via a communication path.

In realizing the functions as the first performance information generation section 111, the second performance generation section 112, the first load value acquisition section 113, the second load value acquisition section 114, the first time prediction section 115, the second time prediction section 116, the comparison section 117, and the read-out processing section 118, the program stored in an internal memory device, for example, the main memory 12, is executed by a microprocessor, for example, the CPU 11, of the computer. The program recorded in a recording medium may be read and executed by the computer.

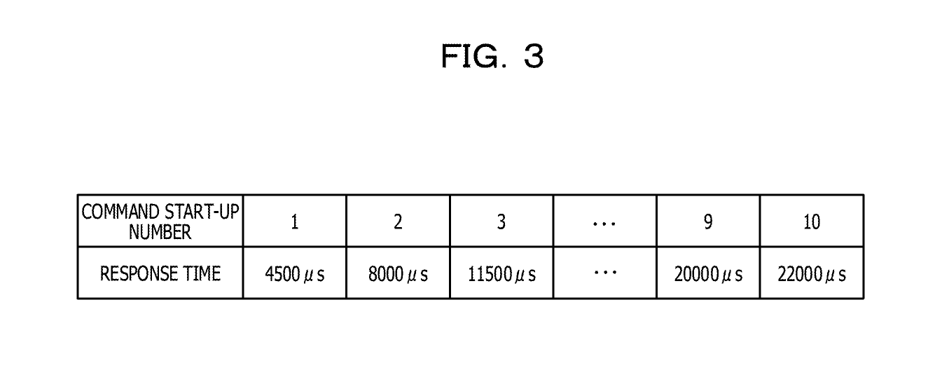

FIG. 3 illustrates an example of an HDD basic performance table. The HDD basic performance table illustrated in FIG. 3 may be included, for example, in the storage system illustrated in FIG. 2. The first performance information generation section 111 generates an HDD basic performance table, for example, first performance information, indicating a read-out process time for reading out data from the HDDs 20 for each number of commands that are redundantly issued to the HDDs 20. For example, the first performance information generation section 111 issues a command to the HDDs 20, for example, at a start-up of the storage device 1, measures a response time from issuance of the command to reception of a response, and thereby, generates the HDD basic performance table. The first performance information generation section 111 measures a plurality of response times while changing the number (a command start-up number) of commands that are redundantly issued. The first performance information generation section 111 stores information regarding the generated HDD basic performance table, for example, in the main memory 12.

As illustrated in FIG. 3, in the HDD basic performance table, a response time is associated with each command start-up number. For example, the HDD basic performance table indicates the relationship between the command start-up number and the response time for the HDDs 20. In FIG. 3, the response time when the command start-up number is 1 is 4500 μs (microseconds), the response time when the command start-up number is 2 is 8000 μs, and the response time when the command start-up number is 3 is 11500 μs. The response time when the command start-up number is 9 is 20000 μs, and the response time when the command start-up number is 10 is 22000 μs.

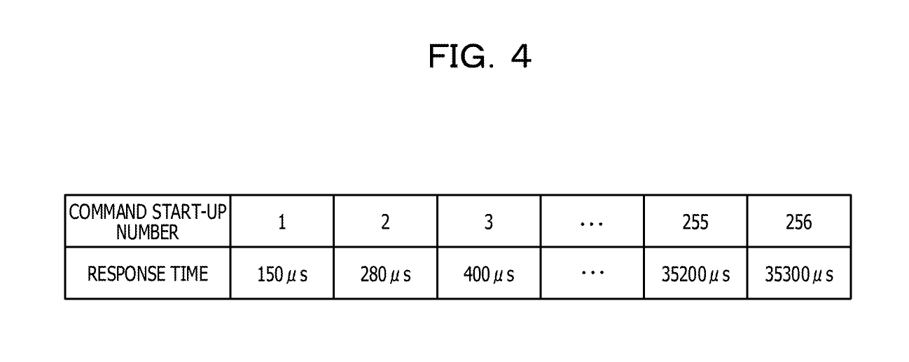

In FIG. 3, the first performance information generation section 111 measures a response time for each of the cases where the command start-up number for the HDDs 20 is 1 to 10. The number of the response times measured by the first performance information generation section 111 may be changed to various numbers, for example, based on the data access performance (basic performance) of the HDDs 20. FIG. 4 illustrates an example of an SSD basic performance table. The SSD basic performance table illustrated in FIG. 4 may be included, for example, in the storage system illustrated in FIG. 2.

The second performance generation section 112 generates an SSD basic performance table, example, second performance information, indicating a read-out process time for reading out data from the SSD 13 for each number of commands that are redundantly issued to the SSD 13. For example, the second performance generation section 112 issues a command to the SSD 13, for example, at a start-up of the storage device 1, measures a response time from issuance of the command to reception of a response, and thereby, generates the SSD basic performance table. The second performance generation section 112 measures a plurality of response times while changing the number (a command start-up number) of commands that are redundantly issued. The second performance generation section 112 stores information regarding the generated SSD basic performance table, for example, in the main memory 12.

As illustrated in FIG. 4, in the SSD basic performance table, a response time is associated with each command start-up number. For example, the SSD basic performance table indicates the relationship between the command start-up number and the response time for the SSD 13. In FIG. 4, the response time when the command start-up number is 1 is 150 μs, the response time when the command start-up number is 2 is 280 μs, and the response time when the command start-up number is 3 is 400 μs. The response time when the command start-up number is 255 is 35200 μs, and the response time when the command start-up number is 256 is 35300 μs.

In FIG. 4, the second performance generation section 112 measures a response time for each of the cases where the command start-up number for the SSD 13 is 1 to 256. The number of command start-up numbers for which the second performance generation section 112 measures the response times may be changed, for example, based on a data access performance (basic performance) of the SSD 13. The maximum number of commands that may be issued to the SSD 13 at a time may be determined in advance by a vender in accordance with a queue depth specification. The number of the command start-up numbers for which the second performance generation section 112 measures the response times may be determined based on the queue depth specification.

The first load value acquisition section 113 acquires, as an HDD load value, for example, a first load value, the number of commands which have been issued to the HDDs 20, processing based on which is not completed, and which are registered, for example, in a command queue. For example, during an operation of the storage system 100, the first load value acquisition section 113 increments the HDD load value by “1” each time the host device 2 starts up a command (I/O) for the HDDs 20, and decrements the HDD load value by “1” when processing for the command is completed. The first load value acquisition section 113 monitors a start-up command number for the HDDs 20.

The second load value acquisition section 114 acquires, as an SSD load value, for example, a second load value, the number of commands which have been issued to the SSD 13, processing based on which is not completed, and which are registered, for example, in a command queue. For example, during an operation of the storage system 100, the second load value acquisition section 114 increments the SSD load value by “1” each time the host device 2 starts up a command (I/O) for the SSD 13, and decrements the SSD load value by “1” when processing for the command is completed. The second load value acquisition section 114 monitors a start-up command number for the SSD 13.

The first time prediction section 115 predicts, as an HDD read prediction time, for example, a first prediction time, a read-out process time for reading out data from the HDDs 20. For example, the first time prediction section 115 predicts the HDD read-out prediction time, based on the HDD basic performance table generated by the first performance information generation section 111 and the HDD load value acquired by the first load value acquisition section 113. The first time prediction section 115 develops information regarding the HDD basic performance table generated by the first performance information generation section 111 and stored, for example, in the main memory 12 in the internal memory of the CPU 11, and thereby, uses the HDD basic performance table.

For example, in FIG. 3, when the HDD load value acquired by the first load value acquisition section 113 is 1, with reference to the HDD basic performance table, the first time prediction section 115 sets, as the HDD read-out prediction time, the response time corresponding to the command start-up number that is the same as the HDD load value. The first time prediction section 115 predicts that it takes 4500 us to complete processing of a single command issued to the HDDs 20. When the HDD load value acquired by the first load value acquisition section 113 is 9, the first time prediction section 115 predicts 20000 μs as the HDD read-out prediction time, based on the HDD basic performance table.

The second time prediction section 116 predicts a read-out process time for reading out data from the SSD 13 as an SSD read-out prediction time, for example, a second prediction time. The second time prediction section 116 may predict the SSD read-out prediction time by a similar method to that used by the first time prediction section 115. For example, the second time prediction section 116 predicts the SSD read-out prediction time, based on the SSD basic performance table generated by the second performance generation section 112 and the SSD load value acquired by a second load acquisition section. The second time prediction section 116 develops information regarding the SSD basic performance table generated by the second performance generation section 112 and stored, for example, in the main memory 12 in the internal memory of the CPU 11, and thereby, uses the SSD basic performance table.

For example, in FIG. 4, when the SSD load value acquired by the second load value acquisition section 114 is 1, the first time prediction section 115 may predict 150 μs as the SSD read-out prediction time, based on the SSD basic performance table. When the SSD load value acquired by the second load value acquisition section 114 is 255, the second time prediction section 116 may predict 35200 μs as the SSD read-out prediction time, based on the SSD basic performance table.

The comparison section 117 compares the HDD read-out prediction time predicted by the first time prediction section 115 and the SSD read-out prediction time predicted by the second time prediction section 116 to each other. For example, the comparison section 117 compares a processing performance of the HDDs 20 and a processing performance of the SSD 13 when a data read-out request is generated from the host device 2 to each other. As a result of comparison performed by the comparison section 117, if the HDD read-out prediction time is equal to or more than the SSD read-out prediction time and data corresponding to the read-out request from the host device 2 is cached to the SSD 13, the read-out processing section 118 reads out data from the SSD 13.

As a result of comparison performed by the comparison section 117, if the HDD read-out prediction time is less than the SSD read-out prediction time, the read-out processing section 118 reads out data corresponding to the read-out request from the host device 2 from the HDDs 20 even when the data is cached to the SSD 13. For example, if it is determined that, while a secondary cache hit ratio is high and a load of the SSD 13 is high, a load of the HDDs 20 is low and actual performances of the SSD 13 and the HDDs 20 are reversed around, the read-out processing section 118 performs a cache miss operation, not a cache hit operation. The actual performance is a data access performance of the SSD 13 or the HDDs 20 at a time when a data access request is generated to the storage device 1 from the host device 2.

For example, in FIG. 3 and FIG. 4, when each of the command start-up numbers for the HDDs 20 and the SSD 13 is 1, the HDD read-out prediction time (4500 μs) is equal to or more than the SSD read-out prediction time (150 μs). Therefore, the read-out processing section 118 reads out data corresponding to a read-out request from the host device 2 from the SSD 13. In FIG. 3 and FIG. 4, when the command start-up number for the HDDs 20 is 3 and the command start-up number for the SSD 13 is 255, the HDD read-out prediction time (11500 μs) is less than the SSD read-out prediction time (35200 μs). In this case, the actual performances of the SSD 13 and the HDDs 20 might be reversed around. Therefore, the read-out processing section 118 reads out data corresponding to the read-out request from the host device 2 from the HDDs 20 even when the data is cached to the SSD 13.

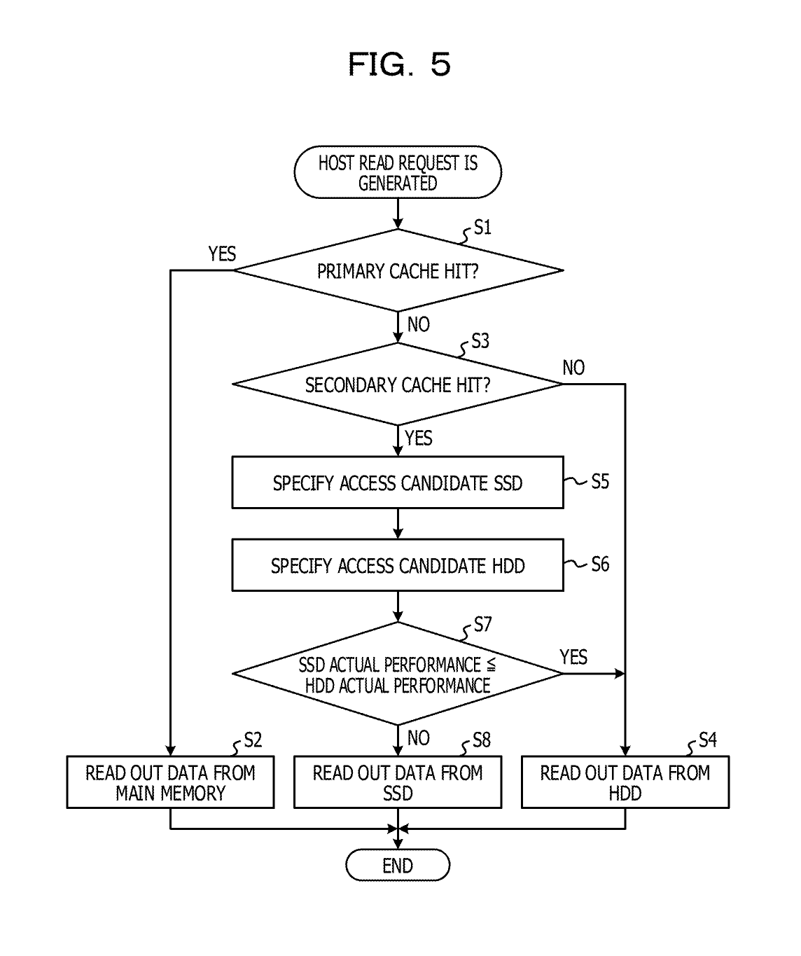

FIG. 5 illustrates an example of data read target device selection processing. The processing illustrated in FIG. 5 may be executed, for example, in the storage system illustrated in FIG. 2. When a read request for reading data stored in the storage device 1 is generated from the host device 2, the read-out processing section 118 determines whether or not read target data exists in the main memory 12, for example, whether or not there is a primary cache hit (Operation S1).

If there is a primary cache hit (YES in Operation S1), the read-out processing section 118 reads out the read target data from the main memory 12 (Operation S2), and the process is ended. If there is not a primary cache hit (NO in Operation S1), the read-out processing section 118 determines whether or not the read target data exists in the SSD 13, for example, whether or not there is a second cache hit (Operation S3).

If there is not a second cache hit (NO in Operation S3), the read-out processing section 118 reads out the read target data from the HDDs 20 (Operation S4), and the process is ended. If there is a second cache hit (YES in Operation S3), the read-out processing section 118 specifies, as an access candidate SSD 13, an SSD 13 in which the read target data exist from the plurality of SSDs 13 of the storage device 1 (Operation S5).

The read-out processing section 118 specifies, as an access candidate HDD 20, an HDD 20 in which the read target data exists from the plurality of the HDDs 20 of the storage device 1 (Operation S6). The comparison section 117 compares the actual performance of the SSD 13 specified in Operation 5 and the actual performance of the HDD 20 specified in Operation S6 to each other (Operation S7).

If the performance of the SSD 13 specified in Operation S5 is equal to or lower than the performance of the HDD 20 specified in Operation S6 (YES in Operation S7), the read-out processing section 118 reads out the read target data from the HDD 20 (Operation S4), and the process is ended. If the performance of the SSD 13 specified in Operation S5 is higher than the performance of the HDD 20 specified in Operation S6 (NO in Operation S7), the read-out processing section 118 reads out the read target data from the SSD 13 (Operation S8), and the process is ended.

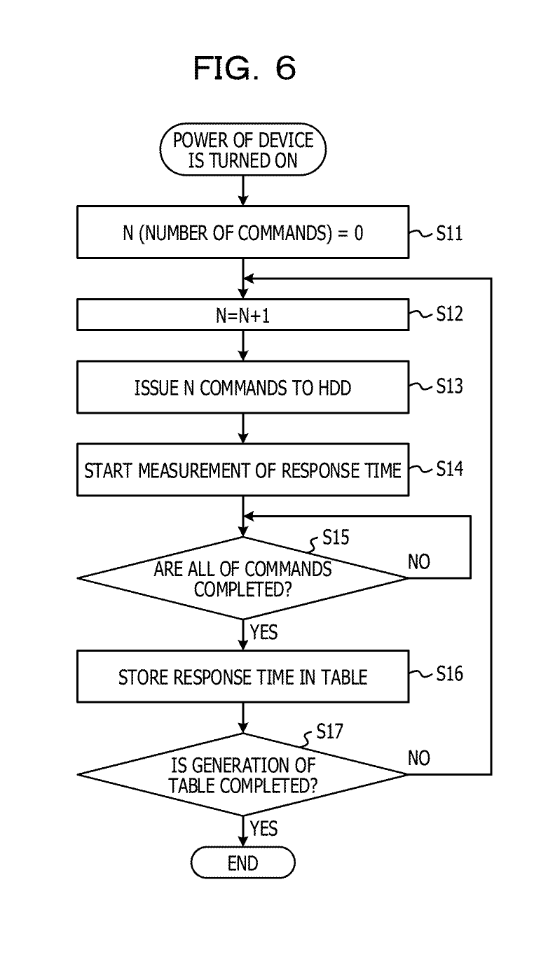

FIG. 6 illustrates an example of HDD basic performance table generation processing. The processing of FIG. 6 may be executed, for example, in the storage system illustrated in FIG. 2. When the power of the storage device 1 is turned on, the first performance information generation section 111 sets “0” for the number N of commands (Operation S11). The first performance information generation section 111 increments the number N of commands by “1” (Operation S12).

The first performance information generation section 111 issues N commands to the HDDs 20 (Operation S13). The first performance information generation section 111 starts measurement of a response time for the issued N commands (Operation S14). The first performance information generation section 111 receives responses to the issued N commands and determines whether or not processing for each of all of the commands is completed (Operation S15).

If processing for each of all of the commands is not completed (NO in Operation S15), the first performance information generation section 111 repeats Operation S15. If processing for each of all of the commands is completed (YES in Operation S15), the first performance information generation section 111 stores the response times for the issued N commands in the HDD basic performance table (Operation S16).

The first performance information generation section 111 measures the response time for the command start-up number and determines whether or not the generation of the HDD basic performance table is completed (Operation S17). If the generation of the HDD basic performance table is not completed (NO Operation S17), the process returns to Operation S12. If the generation of the HDD basic performance table is completed (YES in Operation S17), the process is ended.

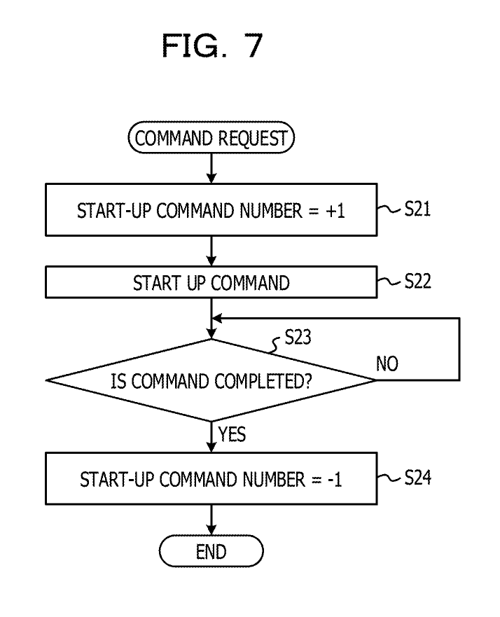

Similar to the generation of the HDD basic performance table by the first performance information generation section 111, the second performance generation section 112 generates the SSD basic performance table by executing Operations S11 to S17 for the SSD 13. In Operation S13, the second performance generation section 112 issues N commands to the SSD 13. FIG. 7 illustrates an example of HDD load value monitoring processing. The processing illustrated in FIG. 7 may be executed, for example, in the storage system illustrated in FIG. 2.

When a command request to the HDDs 20 is generated from the host device 2, the first load value acquisition section 113 increments the start-up command number (the HDD load value) by “1” (Operation S21). The CPU 11 starts up a command for the HDDs 20 (Operation S22). The first load value acquisition section 113 determines whether or not processing for the command started up for the HDDs 20 is completed (Operation S23).

If the processing for the command is not completed (NO in Operation S23), the first load value acquisition section 113 repeats Operation S23. If the processing for the command is completed (YES in Operation S23), the first load value acquisition section 113 decrements the start-up command number (the HDD load value) by “1” (Operation S24), and the process is ended.

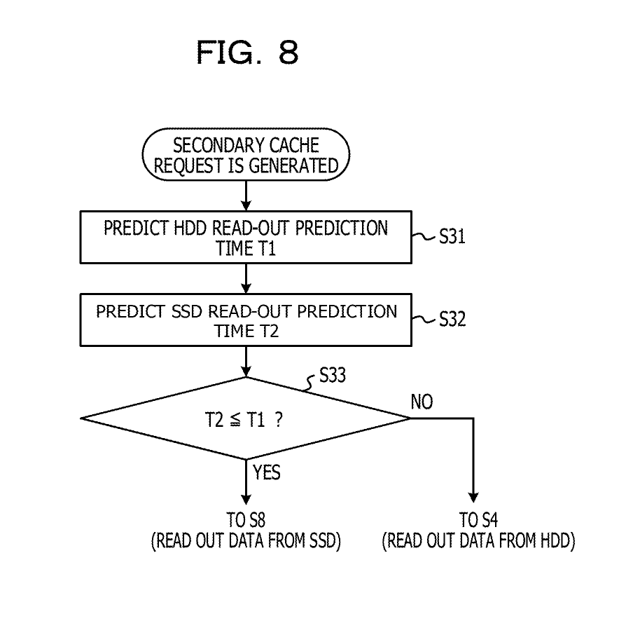

Similar to the HDD load value monitoring processing by the first performance information generation section 111, the second load value acquisition section 114 monitors the SSD load value by executing Operations S21 to S24. FIG. 8 illustrates an example of data read target device selection processing. The processing illustrated in FIG. 8 may be executed, for example, in the storage system illustrated in FIG. 2.

Operations S31 to S33 of FIG. 8 may correspond to Operation S7 of FIG. 5. When a second cache request is generated and an access candidate SSD 13 and an access candidate HDD 20 are specified (Operations S5 and S6), the first time prediction section 115 predicts an HDD read-out prediction time T1 (Operation S31). For example, the first time prediction section 115 predicts the HDD read-out prediction time T1, based on the HDD basic performance table generated by the first performance information generation section 111 and the HDD load value acquired by the first load value acquisition section 113.

The second time prediction section 116 predicts an SSD read-out prediction time T2 (Operation S32). For example, the second time prediction section 116 predicts the SSD read-out prediction time T2, based on the SSD basic performance table generated by the second performance generation section 112 and the SSD load value acquired by the second load value acquisition section 114. The comparison section 117 determines whether or not the SSD read-out prediction time T2 is equal to or less than the HDD read-out prediction time T1 (Operation S33).

If the SSD read-out prediction time T2 is equal to or less than the HDD read-out prediction time T1 (YES in Operation S33), the process proceeds to Operation S8 of FIG. 5. For example, the read-out processing section 118 reads out the read target data from the SSD 13. If the SSD read-out prediction time T2 is more than the HDD read-out prediction time T1 (NO in Operation S33), the process proceeds to Operation S4 of FIG. 5. For example, the read-out processing section 118 reads out the read target data from the HDD 20.

In the controller (the storage control device) 10, the comparison section 117 compares the HDD read-out prediction time predicted by the first time prediction section 115 and the SSD read-out prediction time predicted by the second time prediction section 116 to each other. As a result of comparison performed by the comparison section 117, if the HDD read-out prediction time is equal to or more than the SSD read-out prediction time, the read-out processing section 118 reads out data from the SSD 13, and, if the HDD read-out prediction time is less than the SSD read-out prediction time, the read-out processing section 118 reads out data from the HDD 20.

Therefore, a memory device having a high access speed is selected and a read is performed. For example, when an access load of the SSD 13 is higher than that of the HDD 20, the HDD 20 is selected and a read is performed even when read target data is cached to the SSD 13, and a data access process time may be reduced. For example, even in a state where the actual performances of the SSD 13 and the HDD 20 are reversed around, a memory device having a short data access process time may be selected.

The first time prediction section 115 predicts the HDD read-out prediction time, based on the HDD basic performance table generated by the first performance information generation section 111 and the HDD load value acquired by the first load value acquisition section 113. The second time prediction section 116 predicts the SSD read-out prediction time, based on the SSD basic performance table generated by the second performance generation section 112 and the SSD load value acquired by the second load value acquisition section 114.

Therefore, when there are a small number of cache misses and the load of the SSD 13 is high, data is read out from the HDD 20 having a lower load than that of the SSD 13. The SSD 13 may be used as a secondary cache memory.

There might be cases where, as a total write amount increases, the performance of the SSD 13, which is a semiconductor recording medium, gradually reduces. Because of this characteristic, a difference between the basic performance of the SSD 13 at the time of shipping from the factory and the actual performance of the SSD 13 in use might occur. Due to reduction in performance of the SSD 13, there might be cases where, even in a case where the read-out processing section 118 reads out data from the SSD 13, based on a result of comparison performed by the comparison section 117, an actual process time is shorter when the read-out processing section 118 reads out data from the HDD 20 than when the read-out processing section 118 reads out data from the SSD 13.

Therefore, the SSD basic performance table generated by the second performance generation section 112 may be updated. The second performance generation section 112 updates the SSD basic performance table using a process time which it took for the read-out processing section 118 to read out data from the SSD 13. For example, the second performance generation section 112 measures a response time from issuance of a command to the SSD 13 to completion of processing for the command, and updates the SSD basic performance table using the measured response time.

Therefore, even when the data access performance of the SSD 13 is reduced due to increase in total write amount, aging degradation, and the like, the comparison section 117 performs comparison between the HDD read-out prediction time and the SSD read-out prediction time, based on the corrected SSD basic performance table. The read-out processing section 118 reads out data from a proper SSD 13, based on a result of comparison performed by the comparison section 117.

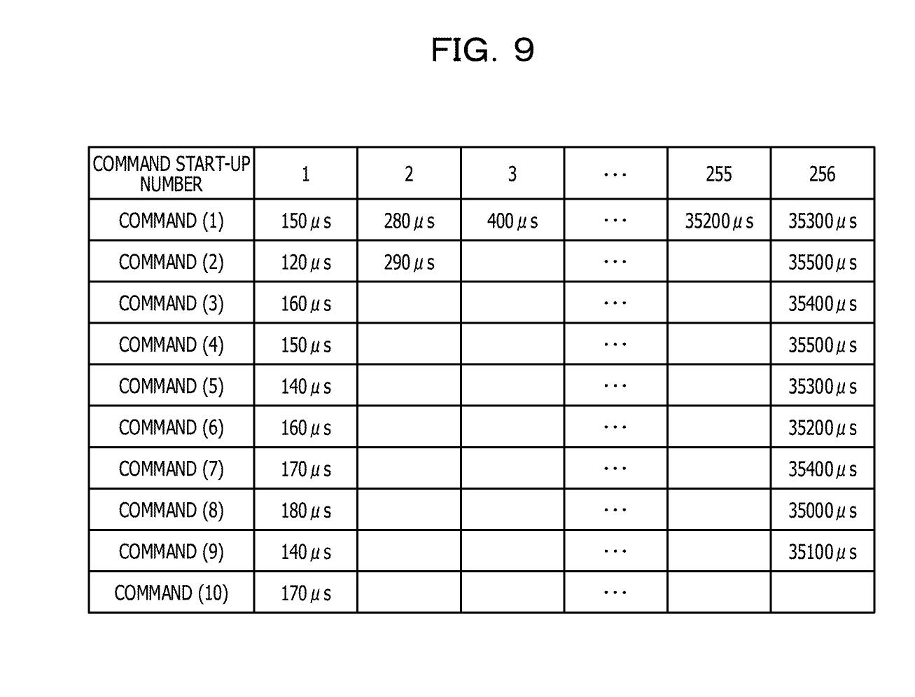

FIG. 9 illustrates an example of an SSD response time table. The SSD response time table illustrated in FIG. 9 may be included, for example, in the storage system illustrated in FIG. 2. The second performance generation section 112 may update the SSD basic performance table by calculating, for each number of commands redundantly issued to the SSD 13, an average value of the plurality of process times which it took for the read-out processing section 118 to read out data from the SSD 13.

The term “redundant” or “redundantly” may include a case where the multiplicity is 1. For example, the second performance generation section 112 records a time which it took to read out data in the SSD response time table illustrated in FIG. 9 each time the read-out processing section 118 reads out data from the SSD 13. The second performance generation section 112 performs recording of the time to the SSD response time table for each command start-up number for the SSD 13.

The second performance generation section 112 stores information regarding the SSD response time table, for example, in the main memory 12. The second performance generation section 112 develops the information regarding the SSD basic performance table stored in the main memory 12 in the internal memory of the CPU 11, and thereby, uses the SSD basic performance table. In FIG. 9, the read-out processing section 118 may perform read-out processing of reading out data from the SSD 13 when the command start-up number is 1 ten times, read-out processing of reading out data from the SSD 13 when the command start-up number is 2 twice, and read-out processing of reading out data from the SSD 13 when the command start-up number is 3 once. The read-out processing section 118 may perform read-out processing of reading out data from the SSD 13 when the command start-up number is 255 once, and read-out processing of reading data from the SSD 13 when the command start-up number is 256 nine times.

The second performance generation section 112 records, as commands (1) to (10), times which it took for the read-out processing section 118 to read out data from the SSD 13 when the command start-up number is 1 in the SSD response time table. The second performance generation section 112 records, as the commands (1) and (2), times which it took for the read-out processing section 118 to read out data from the SSD 13 when the command start-up number is 2 in the SSD response time table. The second performance generation section 112 records, as the command (1), a time which it took for the read-out processing section 118 to read out data when the command start-up number is 3 in the SSD response time table. The second performance generation section 112 records, as the command (1), a time which it took for the read-out processing section 118 to read out data when the command start-up number is 255 in the SSD response time table. The second performance generation section 112 records, as the commands (1) and (9), times which it took for the read-out processing section 118 to read out data from the SSD 13 when the command start-up number is 256 in the SSD response time table.

When the number of times recorded for a single command start-up number has reached a certain number, for example, 10, in the SSD response time table, the second performance generation section 112 calculates an average value of the plurality of times that have been recorded. The second performance generation section 112 updates the response time of the corresponding command start-up number in the SSD basic performance table using the calculated average value, and deletes the time for the corresponding command start-up number recorded in the SSD response time table.

In FIG. 9, the second performance generation section 112 calculates the average value 154 μs of recorded times of the commands (1) to (10) for the command start-up number 1, the recorded times of which reached 10. The second performance generation section 112 updates the response time for the command start-up number 1 in the SSD basic performance table illustrated in FIG. 4 from 150 μs to 154 μs. The second performance generation section 112 deletes the times of the commands (1) to (10) for the command start-up number 1, which have been recorded in the SSD response time table.

In the controller (the storage control device) 10, when the data access performance of the SSD 13 is reduced due to increase in total write amount, aging degradation, and the like, selection of a memory device used for reading out data may be more accurately performed. The HDD 20 may be used as an auxiliary memory device.

Immediately before the HDD 20 falls into a failure state, the operation of the HDD 20 is put in an unstable state, and a response time of a data access to the HDD 20 might not be accurately predicted. There might be cases where, even in such a case where the read-out processing section 118 reads out data from the HDD 20, based on a result of comparison performed by the comparison section 117, immediately before the HDD 20 falls into a failure state, a process time is shorter when the read-out processing section 118 reads out data from the SSD 13 than when the read-out processing section 118 reads out data from the HDD 20.

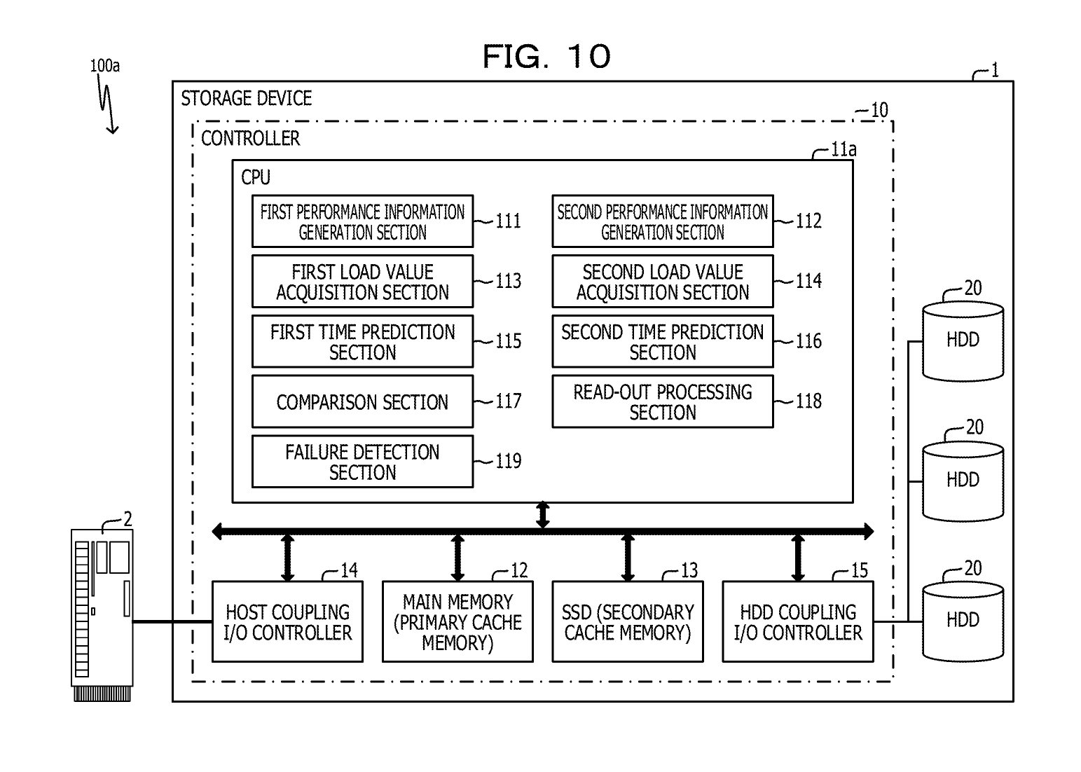

FIG. 10 illustrates an example of a functional configuration of a storage system. In a storage system 100a illustrated in FIG. 10, the controller 10 includes a CPU 11a, instead of the CPU 11 illustrated in FIG. 2.

Similar to the CPU 11 illustrated in FIG. 2, the CPU 11a further has, in addition to the functions as the first performance information generation section 111, the second performance generation section 112, the first load value acquisition section 113, the second load value acquisition section 114, the first time prediction section 115, the second time prediction section 116, the comparison section 117, and the read-out processing section 118, a function as a failure detection section 119. The failure detection section 119 detects a sign of a failure in the HDD 20. For example, the failure detection section 119 detects a sign of a failure, such as a correctable error, a medium error, and the like, before the HDD 20 falls into a complete failure state. Self-Monitoring, Analysis and Reporting Technology (SMART) information of the HDD 20, an existing technique, such as a DISK error statistical method and the like, may be used in detection of a sign of a failure performed by the failure detection section 119.

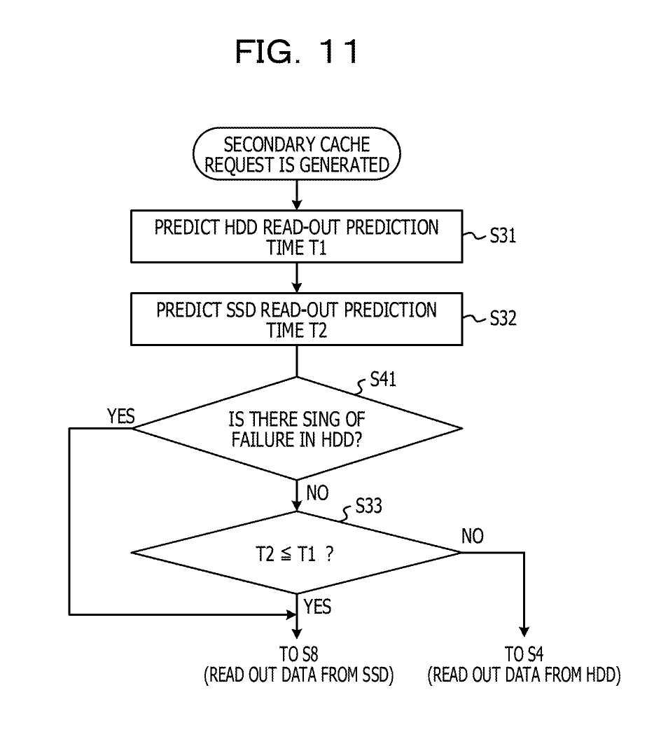

When the failure detection section 119 detects a sign of a failure of the HDD 20, the read-out processing section 118 reads out data from the SSD 13, regardless of a result of comparison performed by the comparison section. FIG. 11 illustrates an example of data read target device selection processing. The processing illustrated in FIG. 11 may be executed in the storage system illustrated in FIG. 10.

Operations S31 to S33 of FIG. 11 may be similar to Operations S31 to S33 of FIG. 8, and the description thereof might be omitted or reduced. When a second cache request is generated, the first time prediction section 115 predicts the HDD read-out prediction time T1 (Operation S31). The second time prediction section 116 predicts the SSD read-out prediction time T2 (Operation S32).

The failure detection section 119 determines whether or not there is a sign of a failure in an access candidate HDD 20 (Operation S41). If there is a sign of a failure in an access candidate HDD 20 (YES in Operation S41), the process proceeds to Operation S8 of FIG. 5. For example, the read-out processing section 118 reads out read target data from the SSD 13.

If there is not a sign of a failure in the access candidate HDD 20 (NO in Operation S41), the comparison section 117 determines whether or not the SSD read-out prediction time T2 is equal to less than the HDD read-out prediction time T1 (Operation S33). If the SSD read-out prediction time T2 is equal to less than the HDD read-out prediction time T1 (YES in Operation S33), the process proceeds to Operation S8 of FIG. 5. For example, the read-out processing section 118 reads out the read target data from the SSD 13.

If the SSD read-out prediction time T2 is more than the HDD read-out prediction time T1 (NO in Operation S33), the process proceeds to Operation S4 of FIG. 5. For example, the read-out processing section 118 reads out the read target data from the HDD 20. As described above, in the controller (the storage control device) 10, when the data access performance of the HDD 20 is reduced immediately before the HDD 20 falls into a failure state, selection of a memory device that is used for reading out data may be more accurately performed.

The first performance information generation section 111 and the second performance generation section 112 may generate the HDD basic performance table and the SSD basic performance table, respectively, for example, at a start-up of the storage device 1.

For example, information regarding the HDD basic performance table and the SSD basic performance table may be stored in the SSD 13 and the like in advance at the time of shipping of the storage device 1 from the factory. In this case, similar advantages to those described above may be achieved, and also, there may be no longer a time for generating the HDD basic performance table and the SSD basic performance table at a start-up of the storage device 1.

The first performance information generation section 111 and the second performance generation section 112 may generate the HDD basic performance table and the SSD basic performance table, respectively, by measuring a response time for every second command start-up number. For example, each of the first performance information generation section 111 and the second performance generation section 112 may measure a response time for every 11th command start-up number or every 51st command start-up number. The first performance information generation section 111 and the second performance generation section 112 may generate the HDD basic performance table and the SSD basic performance table, respectively, by performing an interpolation on the measured response time and calculating a response time for every second command start-up number.

Also, in this case, similar advantages to those described above may be achieved, and a time for generating the HDD basic performance table and the SSD basic performance table may be reduced. For example, when the number of times recorded for a single command start-up number has reached a certain number, for example, 10, in the SSD response time table, the second performance generation section 112 may calculate an average value of the plurality of times that have been recorded.

For example, the second performance generation section 112 may calculate an average value of the plurality of times that have been recorded for each command start-up number each time a certain time has elapsed. Also, in this case, similar advantages to those described above may be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control device comprising:
a processor;
a second memory device coupled to a first memory device so as to be capable of communicating with the first memory device, and having a higher data access performance than a data access performance of the first memory device,
the processor is configured to:
predict, as a first prediction time, a read-out process time for reading out data from the first memory device;
predict, as a second prediction time, a read-out process time for reading out data from the second memory device;
compare the first prediction time and the second prediction time to each other; and
read out, when the first prediction time is equal to or more than the second prediction time data from the second memory device and, when the first prediction time is less than the second prediction time data from the first memory device.

2. The storage control device according to claim 1,
wherein the processor is configured to:
generate first performance information indicating a read-out process time for reading out data from the first memory device for each of numbers of first commands that are issued to the first memory device;
generate second performance information indicating a read-out process time for reading out data from the second memory device for each of numbers of second commands that are issued to the second memory device;
acquire, as a first load value, a number of third commands issued to the first memory device;
acquire, as a second load value, a number of fourth commands issued to the second memory device;
predict the first prediction time, based on the first performance information and the first load value; and
predict the second prediction time, based on the second performance information and the second load value.

3. The storage control device according to claim 2,
wherein the processor is configured to update the second performance information using a process time for reading out data from the second memory device.

4. The storage control device according to claim 2,
wherein the processor is configured to update the second performance information by calculating, for each of the numbers of second commands, an average value of a plurality of process times for reading read out data from the second memory device.

5. The storage control device according to claim 1,
wherein the processor is configured to:
detect a sign of a failure of the first memory device; and
read out, if a sign of a failure is detected, data from the second memory device regardless of a result of the comparison.

6. The storage control device according to claim 1,
wherein the first memory device is a magnetic storage device, and the second memory device is a semiconductor memory.

7. The storage control device according to claim 1, further comprising:
a volatile memory used as a primary cache memory,
wherein the second memory device is used as a second cache memory.

8. A control method comprising:
predicting, by a computer, as a first prediction time, a read-out process time for reading out data from a first memory;
predicting, as a second prediction time, a read-out process time for reading out data from a second memory device coupled to the first memory device so as to be capable of communicating with the first memory device, and having a higher data access performance than a data access performance f the first memory device;
comparing the first prediction time and the second prediction time to each other; and
reading out, when the first prediction time is equal to or more than the second prediction time data from the second memory device and, when the first prediction time is less than the second prediction time data from the first memory device.

9. The control method according to claim 8, further comprising:
generating first performance information indicating a read-out process time for reading out data from the first memory device for each of numbers of first commands that are issued to the first memory device;
generating second performance information indicating a read-out process time for reading out data from the second memory device for each of numbers of second commands that are issued to the second memory device;
acquiring, as a first load value, a number of third commands issued to the first memory device;
acquiring as a second load value, a number of fourth commands issued to the second memory device;
predicting the first prediction time, based on the first performance information and the first load value; and
predicting the second prediction time, based on the second performance information and the second load value.

10. The control method according to claim 9,
wherein the second performance information is updated using a process time for reading out data from the second memory device.

11. The control method according to claim 9,
wherein the second performance information is updated by calculating, for each of the numbers of second commands, an average value of a plurality of process times for reading out data from the second memory device.

12. The control method according to claim 8,
wherein, if a sign of a failure in the first memory device is detected, data is read out from the second memory device regardless of a result of the comparison.

13. The control method according to claim 8,
wherein the first memory device is a magnetic storage device, and the second memory device is a semiconductor memory.

14. The control method according to claim 8,
wherein a storage control device includes a volatile memory used as a primary cache memory, and the second memory device is used as a second cache memory.

15. A storage system comprising:
a processor;
a first memory device;
a second memory device having a higher data access performance than a data access performance of the first memory device; and
an interface controller,
wherein the processor is configured to:
predict, as a first prediction time, a read-out process time for reading out data from the first memory device,
predict, as a second prediction time, a read-out process time for reading out data from the second memory device,
compare the first prediction time and the second prediction time to each other, and
read out, when the first prediction time is equal to or more than the second prediction time, data from the second memory device and, when the first prediction time is less than the second prediction time, data from the first memory device.

16. The storage system according to claim 15,
wherein the processor is configured to:
generate first performance information indicating a read-out process time for reading out data from the first memory device for each of numbers of first commands that are issued to the first memory device;
generate second performance information indicating a read-out process time for reading out data from the second memory device for each of numbers of second commands that are issued to the second memory device;
acquire, as a first load value, a number of third commands issued to the first memory device;
acquire, as a second load value, a number of fourth commands issued to the second memory device;
predict the first prediction time, based on the first performance information and the first load value; and
predict the second prediction time, based on the second performance information and the second load value.

17. The storage system according to claim 16,
wherein the processor is configured to update the second performance information using a process time for reading out data from the second memory device.

18. The storage system according to claim 17,
wherein the processor is configured to update the second performance information by calculating, for each of the numbers of second commands, an average value of a plurality of process times for reading read out data from the second memory device.

19. The storage system according to claim 15,
wherein the processor is configured to:
detect a sign of a failure of the first memory device; and
read out, if a sign of a failure is detected, data from the second memory device regardless of a result of the comparison.

20. The storage system according to claim 15,
wherein the first memory device is a magnetic storage device, and the second memory device is a semiconductor memory.
